(19) United States
(12) Patent Application Publication
(10) Pub. No.: US 2009/0201764 A1
(43) Pub. Date: Aug. 13, 2009

(54) DOWN HOLE MUD SOUND SPEED MEASUREMENT BY USING ACOUSTIC SENSORS WITH DIFFERENTIATED STANDOFF

(75) Inventor: Fenghua Liu, Tomball, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/030,421

(22) Filed: Feb. 13, 2008

(51) Int. Cl. G01V 1/40

(52) U.S. Cl. 367/27

(57) ABSTRACT

A method for determining a velocity of sound traveling in a fluid in a borehole, the method including: placing a logging instrument in the borehole, the instrument including a first acoustic transducer and a second acoustic transducer that are offset from each other in distance to a wall of the borehole, the first transducer adapted to emit a first acoustic wave that is reflected by the wall and the second acoustic transducer adapted to emit a second acoustic wave that is reflected by the wall; determining a difference between a travel time of the first acoustic wave and a travel time of the second acoustic wave; and calculating the velocity using the difference and the offset.

### BACKGROUND OF THE INVENTION

1. Field of the Invention

The present invention relates to downhole measurements of fluid properties in a borehole, and more particularly, to a tool for measuring the sound velocity of a fluid in the borehole.

2. Description of the Related Art

Many types of measurements are generally made when drilling for hydrocarbons. The measurements are performed in a borehole drilled into the earth. The measurements may be made at different depths in the borehole to provide a “well log.” The well log correlates each measurement to a depth at which each measurement was made.

The measurements may be performed while drilling the borehole using a logging instrument in a drill collar. The measurements can also be performed using a wire-line logging instrument with a drill string removed from the borehole.

One important downhole parameter is formation density. To measure the formation density accurately, it is important to know the standoff of the logging instrument. “Standoff” relates to an amount of distance between the surface of the logging instrument and the borehole wall. The standoff can be measured using acoustic waves in a fluid (i.e., drilling mud) in the borehole by detecting the travel time of an acoustic wave reflecting back from the borehole wall. The accuracy of the velocity of sound in the fluid can be a significant factor affecting the accuracy of a measurement of standoff and, consequently, the accuracy of a measurement of the formation density.

In some instances, measurement of a drilling mud property such as sound velocity may be made at the surface. The sound velocity is then used in conjunction with a travel time measurement performed in the borehole to determine the standoff. However, the sound velocity determined at the surface may not accurately represent the sound velocity of the drilling mud downhole.

Therefore, what are needed are techniques for accurately measuring the sound velocity of a fluid in a borehole.

### BRIEF SUMMARY OF THE INVENTION

Disclosed is one example of a method for determining a velocity of sound traveling in a fluid in a borehole, the method including: placing a logging instrument in the borehole, the instrument including a first acoustic transducer and a second acoustic transducer that are offset from each other in distance to a wall of the borehole, the first transducer adapted to emit a first acoustic wave that is reflected by the wall and the second acoustic transducer adapted to emit a second acoustic wave that is reflected by the wall; determining a difference between a travel time of the first acoustic wave and a travel time of the second acoustic wave; and calculating the velocity using the difference and the offset.

Also disclosed is an embodiment of an apparatus for determining a velocity of sound of a fluid in a borehole, the apparatus including: a logging instrument; a first transducer that is a first distance from a wall of the borehole, the first transducer adapted for emitting a first acoustic wave; a second transducer that is a second distance from the wall of the borehole, the second transducer adapted for emitting a second acoustic wave, wherein the second distance is offset from the first distance; and an electronics unit adapted for receiving a first signal from the first transducer and a second signal from the second transducer, for determining a difference in travel times between the acoustic waves, and for determining the velocity from the difference and the offset.

Further disclosed is an embodiment of a computer program product including machine readable instructions stored on machine readable media for determining a velocity of sound of a fluid in a borehole, the product including machine executable instructions for: determining a difference between a travel time of a first acoustic wave that is reflected by a wall of the borehole and a travel time of a second acoustic wave that is reflected by the wall of the borehole wherein the distance traveled by the first acoustic wave is offset from the distance traveled by the second acoustic wave; calculating the velocity using the difference and the offset; and logging the velocity.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging instrument in a borehole penetrating the earth;

FIG. 2 illustrates aspects of an exemplary dual sensor transducer assembly used with the logging instrument;

FIGS. 3A and 3B, collectively referred to as FIG. 3, illustrate an exemplary embodiment of a computer/microprocessor coupled to the logging instrument; and;

FIG. 4 presents one example of a method for determining a velocity of sound of a fluid in the borehole.

### DETAILED DESCRIPTION OF THE INVENTION

Disclosed are techniques for measuring the velocity of sound traveling in a fluid that is in a borehole. The measuring is generally performed in the borehole. The techniques include a method and an apparatus. The techniques call for using two acoustic transducers where each transducer is used to transmit an acoustic wave. In one embodiment, the two acoustic transducers may be used to transmit acoustic waves simultaneously and receive the acoustic waves after the waves are reflected by the wall of the borehole. The techniques call for the distance from each acoustic transducer to the borehole wall to be different. The difference between the distances is referred to as “offset,” which is a given constant as a design parameter of a transducer assembly. Because of the offset, the travel time for each acoustic wave will be different. By knowing the offset constant, the velocity of sound traveling in the fluid can be related to the difference in travel times. Subsequently, the standoff can be calculated using the sound velocity and at least one of the travel times.

The benefit of this technique is that a measurement of sound velocity does not rely on absolute accuracy of most related parameters, which can change significantly in downhole harsh environments. With each acoustic transducer subject to the same inaccuracies of parameters, the inaccuracies cancel each other out. As a result, improved accuracy and repeatability can be achieved.

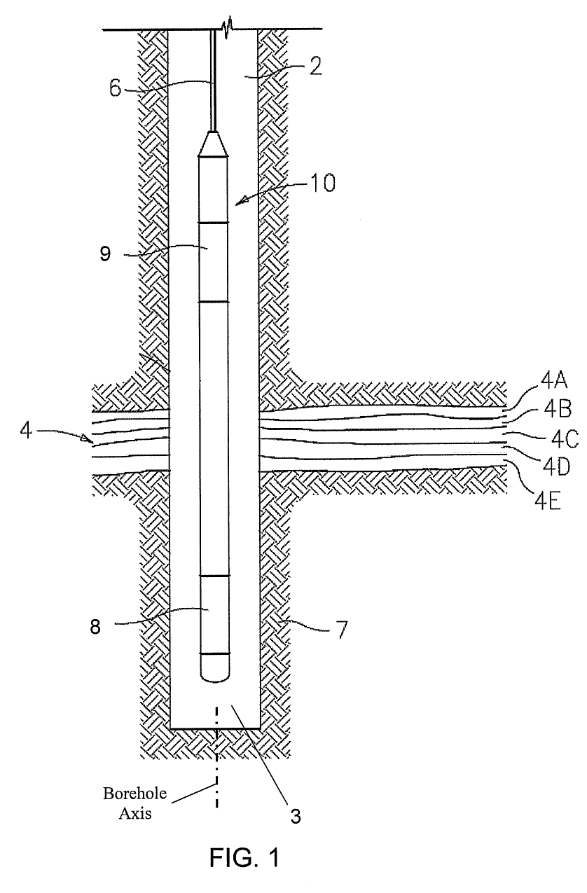

Referring to FIG. 1, an embodiment of a well logging instrument 10 is shown disposed in a borehole 2. The borehole 2 is drilled through earth 7 and penetrates formations 4, which include various formation layers 4A-4E. The logging instrument 10 is typically lowered into and withdrawn from the borehole 2 by use of an armored electrical cable 6 or similar conveyance as is known in the art. The borehole 2 is filled with borehole fluid 3. The borehole fluid 3 may include drilling mud, formation fluid, or any combination thereof. The logging instrument 10 includes a transducer assembly 8 and an electronics unit 9.

For the purposes of this discussion, the borehole 2 is depicted in FIG. 1 as vertical and the formations 4 are depicted as horizontal. The apparatus and method however can be applied equally well in deviated or horizontal wells or with the formation layers 4A-4E at any arbitrary angle. The apparatus and method are equally suited for use in logging while drilling (LWD) applications and in open-borehole and cased-borehole wireline applications. In LWD applications, the apparatus may be disposed in a drilling collar.

For convenience, certain definitions are presented. The term “standoff” relates to an amount of distance between a surface of a transducer on the logging instrument 10 and the wall of the borehole 2. The term “offset” relates to a distance between two transducers in the logging instrument 10. The distance is measured in a direction radial to the borehole 2 (i.e., normal to longitudinal axis 5 shown in FIG. 1). Because the offset may be determined by the structure of the transducer assembly 8, the offset is generally a constant distance. For illustrative purposes, the term “transducer” relates to a device for transmitting and receiving an acoustic wave. However, the apparatus and the method are equally suited for use in using a separate transducer for transmitting and a separate transducer for receiving the acoustic wave. The term “simultaneously” relates to transmitting at least two acoustic waves by the same transmitting driver (transducer), or, within a narrow time window. The narrow time window being close to zero, such as three orders of magnitude smaller than the travel time of the acoustic wave through the fluid.

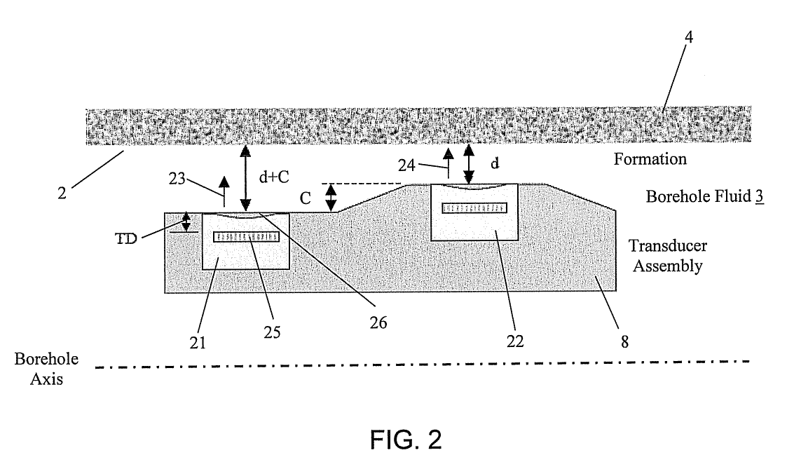

FIG. 2 illustrates aspects of an exemplary embodiment of the transducer assembly 8. For illustrative purposes, the transducer assembly 8 is depicted horizontally in the borehole 2. The transducer assembly 8 includes a first transducer 21 and a second transducer 22. The first transducer 21 is offset from the second transducer 22 by a distance C. That is to say, the first transducer 21 is farther from the wall of the borehole 2 than the second transducer 22 by the distance C. The first transducer 21 transmits a first acoustic wave 23 and receives the reflected acoustic wave 23. Similarly, the second transducer transmits a second acoustic wave 24 and receives the second reflected acoustic wave 24. Also illustrated in FIG. 2 with respect to the first transducer 21 is a distance, TD, from a crystal 25 to a surface 26. The distance TD is the distance the first acoustic wave 23 must travel from the crystal 25 to the surface 26 of the first transducer 21. The distance TD is also the distance the first acoustic wave 23 must travel after being reflected by the wall of the borehole 2 and traveling from the surface 26 to the crystal 25. The crystal 25 is used to generate and receive the first acoustic wave 23 in the transducer 21. In the embodiment of FIG. 2, the second transducer 22 has the same dimensions as the first transducer 21 and, therefore, has the same distance TD from crystal to surface.

Referring to FIG. 2, the transducer 22 has an amount standoff shown as “d.” Thus, the distance from the wall of the borehole 2 to the first transducer 21 is equal to the offset plus the standoff or (C+d). Also referring to FIG. 2, t1 represents the round trip travel time of the first acoustic wave 23 traveling from the surface 26 to the wall of the borehole 2 and back to the surface 26 of the first transducer 21. Similarly, t2 represents the round trip travel time of the second acoustic wave 24.

Equation 1 is used to determine the velocity of sound, V, of the fluid 3 where (d+C) represents the distance from the first transducer 21 to the wall of the borehole 2 (standoff plus offset); d represents the distance from the second transducer 22 to the wall of the borehole 2 (standoff); C represents the offset; and t1 and t2 are the round trip travel times defined above.

$$V = \frac{( d + C ) * 2}{t 1} = \frac{d * 2}{t 2} \qquad ( 1 )$$

To determine the travel time t1 of the first acoustic wave 23, the time the first acoustic wave travels within the transducer 21 must be accounted for. The acoustic 23 wave travels an added distance 2TD (crystal 25 to surface 26 and surface 26 to crystal 25, see FIG. 2). The time to travel the distance 2TD is represented as tt. Because the second transducer 22 has the same dimensions as the first transducer 21, the second acoustic wave 24 will also travel the same added distance 2TD in the same time tt. Therefore, the measured travel time for the first acoustic wave 23 equals (t1+tt). Similarly, the measured travel time for the second acoustic wave 24 equals (t2+tt).

Equation (2) determines V using the measured travel time for the first acoustic wave 23, (t1+tt), and the measured travel time for the second acoustic wave 22, (t2+tt), where dt represents the difference between the measured travel times.

$$V = \frac{( ( d + C * 2 ) - ( d * 2 ) )}{t 1 - t 2} = \frac{C * 2}{( t 1 + tt ) - ( t 2 + tt )} = \frac{C * 2}{dt} \qquad ( 2 )$$

Knowing the velocity of sound V in the fluid 3, the standoff d can be determined using equation (3).

$$d = \frac{V * ( t 1 + tt )}{2} - C = \frac{V * ( t 2 + tt )}{2} \qquad ( 3 )$$

Velocity of sound measurement error ΔV can be determined with respect to dt as shown in equation (4) where Δdt represents error in the difference between the measured travel times and the remainder of the variables as defined above.

$$Δ V = - C * 2 \frac{Δ d t}{d {t}^{2}} \qquad ( 4 )$$

From equation (4), the velocity of sound measurement error ΔV can be approximated as shown in equation (5) with the variables as defined above.

$$Δ V \approx - \frac{Δ dt}{C} * {V}^{2} \qquad ( 5 )$$

With favorable signal quality and high sampling rate, a resolution of the time differential dt around one nano-second can be achieved. However, the downhole environment can be subject to excessive electrical noise and mechanical vibration, which can distort signals received by the transducers 21 and 22. By using techniques such as simultaneous transmitting, signal over sampling, and signal cross correlation, the resolution of dt to within twenty nano-seconds can be achieved according to experience.

For example, with an average velocity of sound in the fluid 3 of 1480 meters per second and the time resolution of measurements of dt under 20×10⁻⁹ seconds, the velocity of sound measurement error can be approximated as shown in equation (6).

$$\vert Δ V \vert \approx \frac{20 * {10}^{- 9}}{C} * {1480}^{2} \qquad ( 6 )$$

Percentage error of the measurement of the velocity of sound in the fluid 3 can be approximated as shown in equation (7) with offset C represented in millimeters.

$$\frac{\vert Δ V \vert}{V} * 100 \approx \frac{20 * {10}^{- 9}}{C / 1000} * 1480 * 100 = \frac{2.96}{C} \qquad ( 7 )$$

From equation (7) and with an offset C of 10 mm, the percentage error of the measurement of the velocity of sound V can be under 0.3%. Since the measurement of the velocity of sound V is based on the difference in the measurements of the travel times of the acoustic waves 23 and 24, most other error factors that are common to the first transducer 21 and the second transducer 22 are canceled out. For example, a change in the velocity of sound in one transducer body can effect the accuracy of the measurement of the velocity of sound traveling in the fluid 3 if only one transducer and one acoustic wave is used to measure the travel time. In the embodiment of FIG. 2, a differential time measurement is used using the first transducer 21 and the second transducer 22. The first transducer 21 is similar to the second transducer 22 so any changes in the velocity of sound in the transducer bodies will affect the transducers 21 and 22 the same and, therefore, be canceled out. Similarly, any errors in the electronic unit 9 common to the transducers 21 and 22 such as digital signal processing time delays in firmware will be canceled out.

One assumption for the above accuracy analysis is that the axis of the instrument 10 is parallel to the axis of the borehole 2. Slight deviation from this assumption could happen when the instrument 10 is tilted in the measuring process. This impact on accuracy will be limited when placing the two transducers 21 and 22 as close to each other as possible. On the other hand, the repetition rate of sound speed measurements can be more than a thousand times per second while the fluid sound speed does not change abruptly. Thus, it is possible to take advantage of a large number of measurements to limit statistical error caused by movement of the axis of the instrument 10 during the measuring process.

Generally, the well logging instrument 10 includes adaptations as may be necessary to provide for operation during drilling or after a drilling process has been completed.

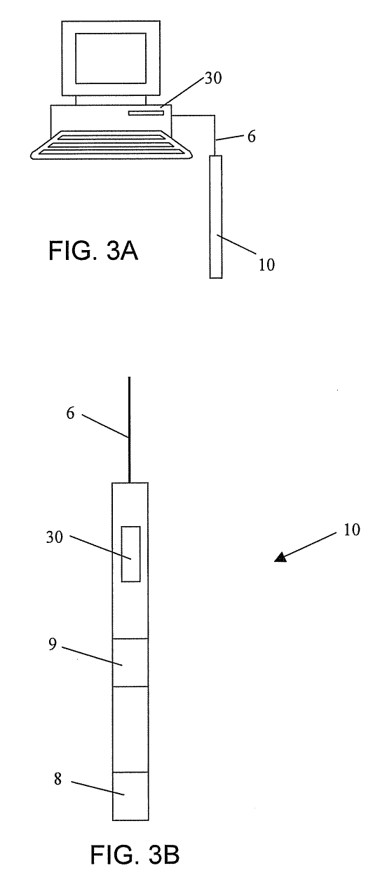

Referring to FIG. 3, an apparatus for implementing the teachings herein is depicted. In FIG. 3, the apparatus includes a computer 30 coupled to the well logging instrument 10. In the embodiment of FIG. 3A, the computer 30 is shown disposed separate from the logging instrument 10, at the surface of the earth 7 for example. In the embodiment of FIG. 3B, a microprocessor 30 is shown disposed within the logging instrument 10. The microprocessor 30 may also be included as part of the electronics unit 9. Generally, the computer/micro-processor 30 includes components as necessary to provide for the real time processing of data from the well logging instrument 10. Exemplary components include, without limitation, at least one processor, storage, memory, input devices, output devices and the like. As these components are known to those skilled in the art, these are not depicted in any detail herein.

Generally, some of the teachings herein are reduced to an algorithm that is stored on machine-readable media. The algorithm is implemented by the computer 30 and provides operators with desired output. The output is typically generated on a real-time basis.

The logging instrument 10 may be used to provide real-time determination of the velocity of sound of the borehole fluid 3. As used herein, generation of data in “real-time” is taken to mean generation of data at a rate that is useful or adequate for making decisions during or concurrent with processes such as production, experimentation, verification, and other types of surveys or uses as may be opted for by a user or operator. Accordingly, it should be recognized that “real-time” is to be taken in context, and does not necessarily indicate the instantaneous determination of data, or male any other suggestions about the temporal frequency of data collection and determination.

A high degree of quality control over the data may be realized during implementation of the teachings herein. For example, quality control may be achieved through known techniques of iterative processing and data comparison. Accordingly, it is contemplated that additional correction factors and other aspects for real-time processing may be used. Advantageously, the user may apply a desired quality control tolerance to the data, and thus draw a balance between rapidity of determination of the data and a degree of quality in the data.

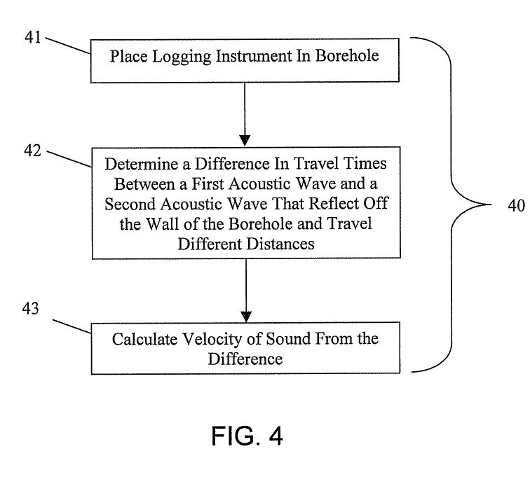

FIG. 4 presents one example of a method 40 for determining the velocity of sound of the borehole fluid 3. The method 140 calls for placing (step 41) the logging instrument 10 into the borehole 2. Further, the method 40 calls for determining (step 42) a difference in travel times between the first acoustic wave 23 and the second acoustic wave 24. Inherent in step 42 are the mechanics of transmitting and receiving the acoustic waves 23 and 24. The first acoustic wave 23 travels a distance that is different from the distance traveled by the second acoustic wave 24. The difference in distances or offset is known. Further, the method 40 calls for calculating (step 43) the velocity of sound of the borehole fluid 3 using the difference and the offset.

In certain embodiments of the instrument 10, more than two transducers may be used to determine the velocity of sound in the borehole fluid 3. In these embodiments, each transducer may have an offset different from the offsets of the other transducers. The electronics unit 9 can determine differences between the travel times of the acoustic waves emitted by the transducers. In addition, the electronics unit 9 can use the differences to calculate the velocity.

In certain embodiments of the instrument 10, multiple frequencies are used for the first acoustic wave 23 and the second acoustic wave 24. Multiple frequencies may be used to insure providing acoustic waves without undue absorption by the borehole fluid 3. When multiple frequencies are used, frequency tuning may also be provided. “Frequency tuning” relates to making several determinations of the sound velocity with each determination using a different frequency. The sound velocities resulting from the multiple frequencies are then analyzed for convergence to a specific velocity.

In certain embodiments, the electronics unit 9 may be disposed at least one of in the logging instrument and at the surface of the earth 7.

In support of the teachings herein, various analysis components may be used, including digital and/or analog systems. The system may have components such as a processor, analog to digital converter, digital to analog converter, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, motive force (such as a translational force, propulsional force, a rotational force, or an acoustical force), digital signal processor, analog signal processor, sensor, transmitter, receiver, transceiver, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The term “including” is intended to be inclusive such that there may be additional elements other than the elements listed.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for determining a velocity of sound traveling in a fluid in a borehole, the method comprising:
placing a logging instrument in the borehole, the instrument comprising a first acoustic transducer and a second acoustic transducer that are offset from each other in distance to a wall of the borehole, the first transducer adapted to emit a first acoustic wave that is reflected by the wall and the second acoustic transducer adapted to emit a second acoustic wave that is reflected by the wall;
determining a difference between a travel time of the first acoustic wave and a travel time of the second acoustic wave; and
calculating the velocity using the difference and the offset.

2. The method of claim 1, wherein the first acoustic wave and the second acoustic wave are emitted simultaneously.

3. The method of claim 2, wherein determining comprises calculating the travel time difference between the two acoustic waves by using at least one of signal cross correlation and signal over sampling.

4. The method of claim 1, wherein determining comprises:
measuring the travel time of the first acoustic wave;
measuring the travel time of the second acoustic wave; and
calculating the difference between the travel times.

5. The method of claim 1, wherein calculating comprises solving the relationship:
V=(C*2)/dt
where V represents the velocity; C represents an amount of offset; and dt represents the difference between the travel time of the first acoustic wave and the travel time of the second acoustic wave.

6. The method of claim 3, further comprising determining a standoff of the instrument by solving the relationship:
d=(V*(t1+tt))/2
where d represents the offset; t1 represents the travel time of the first acoustic wave within the borehole fluid; and tt represents a travel time of the first acoustic wave within the first transducer.

7. The method of claim 1, wherein the first acoustic wave and the second acoustic wave comprise multiple frequencies.

8. The method of claim 7, further comprising frequency tuning to determine convergence to a specific velocity.

9. The method of claim 1, wherein a plurality of travel time differences are used to calculate the velocity.

10. An apparatus for determining a velocity of sound of a fluid in a borehole, the apparatus comprising:
a logging instrument;
a first transducer that is a first distance from a wall of the borehole, the first transducer adapted for emitting a first acoustic wave;
a second transducer that is a second distance from the wall of the borehole, the second transducer adapted for emitting a second acoustic wave, wherein the second distance is offset from the first distance; and
an electronics unit adapted for receiving a first signal from the first transducer and a second signal from the second transducer, for determining a difference in travel times between the acoustic waves, and for determining the velocity from the difference and the offset.

11. The apparatus of claim 10, wherein the electronics unit is further adapted for determining a standoff between the logging instrument and the wall of the borehole.

12. The apparatus of claim 10, wherein at least one of the first transducer and the second transducer comprises a crystal.

13. The apparatus of claim 10, wherein the difference between the first distance and the second distance is about ten millimeters.

14. The apparatus of claim 10, wherein at least one of the first transducer and the second transducer comprises an acoustic transmitter and an acoustic receiver.

15. The apparatus of claim 10, wherein the first transducer is adapted for emitting the first acoustic wave at multiple frequencies, the second transducer is adapted for emitting the second acoustic wave at the multiple frequencies, and the electronics unit is adapted for determining the velocity at each frequency.

16. The apparatus of claim 15, wherein the electronics unit is adapted for frequency tuning to determine convergence to a specific velocity.

17. A computer program product comprising machine readable instructions stored on machine readable media for determining a velocity of sound of a fluid in a borehole, the product comprising machine executable instructions for:
determining a difference between a travel time of a first acoustic wave that is reflected by a wall of the borehole and a travel time of a second acoustic wave that is reflected by the wall of the borehole wherein the distance traveled by the first acoustic wave is offset from the distance traveled by the second acoustic wave;
calculating the velocity using the difference and the offset; and
logging the velocity.

18. The product as in claim 14, further comprising determining a standoff of a logging instrument in the borehole, the instrument adapted for emitting the first acoustic wave and the second acoustic wave.
